(19) United States
(12) Patent Application Publication
(10) Pub. No.: US 2003/0085801 A1
(43) Pub. Date: May 8, 2003

(54) Truncated asynchronous paging method

(76) Inventors: Daniel R. Tayloe, Phoenix, AZ (US); Yih Guan Jan, Phoenix, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/000,912

(22) Filed: Nov. 2, 2001

(51) Int. Cl. H04Q 1/30; G08B 5/22

(52) U.S. Cl. 340/7.43; 370/347

(57) ABSTRACT

A truncated asynchronous paging method is a hybrid of synchronous paging and asynchronous paging modes. A time slot 106 of paging messages (140-163) is formatted into N paging message groups of M paging messages per group. The paging messages (140-163) are then transmitted in order to maximize the throughput of paging messages while providing the highest resistance to loss of data due to fading.

### BACKGROUND OF THE INVENTION

The present invention pertains to paging and more particularly for arrangements for paging messages.

Generally, there are two paging modes. The synchronous mode and the asynchronous mode. The current CDMA (Code Division Multiple Access) paging channel supports both of these paging modes.

The current asynchronous paging mode provides a relatively high throughput, but at an unacceptably high loss rate. This paging mode trades a relatively high throughput for a lack of immunity to page losses due to fading of over-the-air transmissions. For a fade situation in the asynchronous mode, many pages are lost. High page loss rates cause missed call terminations, resulting in missed revenue and dissatisfied customers.

On the other hand, synchronous paging provides relatively low loss rate due to fading, however, the amount of paging messages that may be transmitted in the synchronous paging mode is considerably less than the asynchronous paging mode. Low paging capacity of a system provides inherent inefficiencies and is costly for system operators since more paging equipment is required to achieve the same paging throughput.

Since the RF (Radio Frequency) spectrum is the most valuable resource in a communication system, more transmission equipment as required by synchronous paging would be more costly to paging system operators thereby driving up the price of paging services.

Accordingly, it would be highly desirable to provide a paging method having more paging throughput with low paging loss due to fading. Furthermore, it would be highly advantageous to provide such a paging method using less transmission equipment, power and bandwidth.

### BRIEF DESCRIPTION OF THE DRAWING

FIG. 1 is a layout diagram of a synchronous paging mode stream.

FIG. 2 is a layout diagram of an asynchronous paging mode stream.

FIG. 3 is a block diagram of a communication system interfacing with users in accordance with the present invention.

FIG. 4 is a layout of a Truncated Asynchronous Paging stream in accordance with the present invention.

FIG. 5 is a layout diagram of a truncated asynchronous paging stream in accordance with the present invention.

FIG. 6 is a plot of loss rate versus pages per slot for the present invention in comparison with prior art methods.

### DESCRIPTION OF THE PREFERRED EMBODIMENT

FIG. 1 depicts a layout of an 80 millisecond (ms) timeslot 100 of a CDMA paging frame. This frame arrangement is useful for IS95 and CDMA 2000 systems. Timeslot 100 includes four pages, page 1 through page 4. The paging mode shown is the synchronous paging mode. In the synchronous paging mode the pages, page 1 through page 4, are spread out in time from each other and start on a 20 ms time boundary. The synchronous paging mode has the advantage of resistance to possible fading. A one millisecond fade will wipe out typically only one page but will not affect the transmission or reception of the next page because of the time-spaced separation. In the synchronous paging mode, the next page begins at the start of the next time slot so that a time spacing is created. However, due to the time separation, synchronous paging is wasteful of unused information bits. This is due to the fact that each new page must begin on a specified time boundary. Therefore, the synchronous mode of paging provides very good resistance to fading, however, the throughput of paging information is substantially diminished.

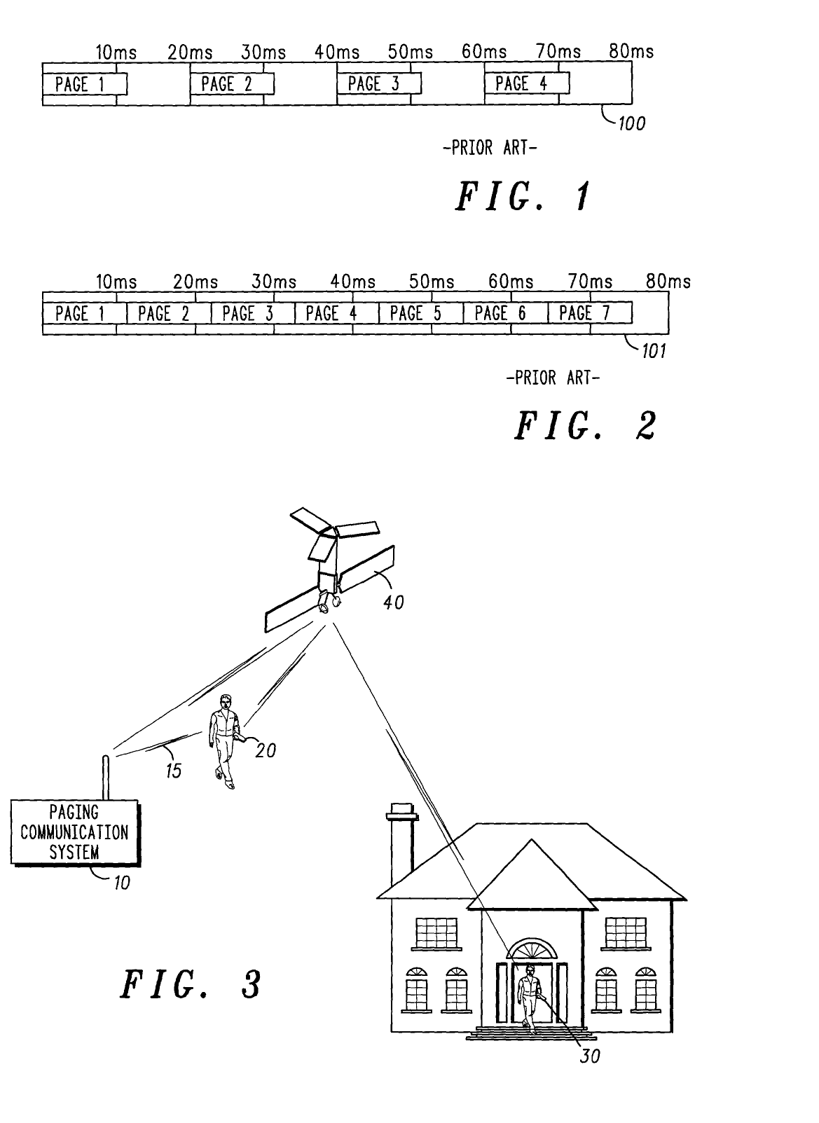

FIG. 2 depicts a layout of a paging slot 101 of a paging frame in the asynchronous paging mode. Paging slot 101 is an 80 millisecond slot which includes seven pages, page 1 through page 7. Page 1 through page 7 are aligned end to end without any bit breaks until the end of the paging slot 101.

It can be observed from a comparison of the asynchronous paging mode of FIG. 2 with the synchronous paging mode of FIG. 1, that the throughput of the asynchronous mode is greatly increased. That is seven pages may be put through in an 80 millisecond paging slot in the asynchronous mode while only four pages may be put through in an 80 millisecond slot in the synchronous mode.

Since the paging timeslot 101 is transmitted over the air, the timeslot is subject to wireless interference or fading during transmission. The successful reception over the air by a paging unit requires the successful reception of all the pages before it up through the 80 millisecond paging slot 101. One occurrence of a fade for as little as one millisecond will compromise the information of all the pages during and after the page. In the worst case, if the fade occurred during page one, all pages, page one through page 7, of the asynchronous paging slot will be lost. Although the asynchronous paging slot arrangement includes a higher throughput, it is subject to loss of many pages with a single incidence of fading.

Referring to FIG. 3, a simplified paging system is shown. Paging communication system 10 transmits a synchronous paging frame or asynchronous paging frame 15 to mobile paging devices 20 and 30. As these pages are transmitted over the air, they are subject to noise distortion, atmospheric distortion and various other forms of distortion, all individually or collectively termed fading. In the asynchronous paging mode shown in FIG. 2, for example, if a prior paging slot to 101 were subjected to fading then pages 2 and 3 which, for example, where intended for paging units 20 and 30 would be compromised and unreceivable by paging units 20 and 30.

In addition, if there were many paging users, the synchronous mode of paging depicted in FIG. 1 would be inefficient to provide paging services to each of the many paging devices. Additionally, a satellite paging transmitter 40 may formulate and transmit the paging slots to mobile paging units 20 and 30 similar to paging communication system 10.

Fading loss is of critical importance. Paging systems should exhibit no more than two percent dropped calls in total and more specifically, dropped calls due to fading should be minimized to one percent or less. Many paging systems typically make two delivery attempts for a given page. Therefore, a ten percent page message loss due to fading causes one percent of all calls to be dropped given two successive page attempts. Likewise, a fifteen percent page message loss causes 2.25% of calls to be dropped and a 25% loss due to fading causes 6.25% of calls to be dropped. Therefore, referring to FIG. 2 again, if a one millisecond fade occurs prior to slot 101 all seven pages would be lost and the loss rate would be at an unacceptably high level.

Referring to FIG. 4, an embodiment of the present invention is depicted in layout form. The 80 millisecond paging slot 105 is shown to include 20 pages, 110 through 129. These pages are grouped in groups of five to comprise four groups 130 through 133. Paging group 130 includes pages 110 through 114; group 131 includes pages 115 through 119; group 132 includes pages 120 through 124; and group 133 includes pages 125 through 129. Each group is separated in time from the next group by 260 microseconds approximately and is aligned so that each group of messages begins on a frame boundary.

This page message ordering arrangement of time slot 105 is called Truncated Asynchronous Paging or TAP. This Truncated Asynchronous Paging arrangement delivers 20 pages per 80 millisecond timeslot with breaks in between each group 130-133 of five pages. This arrangement of page messages is termed a truncated asynchronous paging of length N=5, 20 pages per slot. M which is the number of pages in a group is equal to five for this example.

Referring to FIG. 5, a preferred embodiment of this invention is shown. Paging slot 106 has eight (170-177), three message groups of pages, 140 through 163. That is, there is a total of 24 paging messages grouped in an 80 millisecond paging slot 106. The first paging group 170 includes paging messages 140-142. The grouping of three paging messages per group and eight groups of pages was found to be the best compromise between throughput of paging messages and providing for low loss rates due to fading.

Referring again to FIG. 3, paging communication system 10 or satellite 40 formats the grouping of paging messages as shown in FIG. 5 and transmit this paging slot over the air to paging devices 20 and 30. Paging devices 20 and 30 would receive their appropriate pages and decode the message. That is, the communication system 10 or satellite 40 formulates the paging message shown in FIG. 5 and transmits this paging slot over the air to devices 20 and 30. Devices 20 and 30 receive the appropriate paging message in the paging slot and decode this message for receiving their information via the paging message.

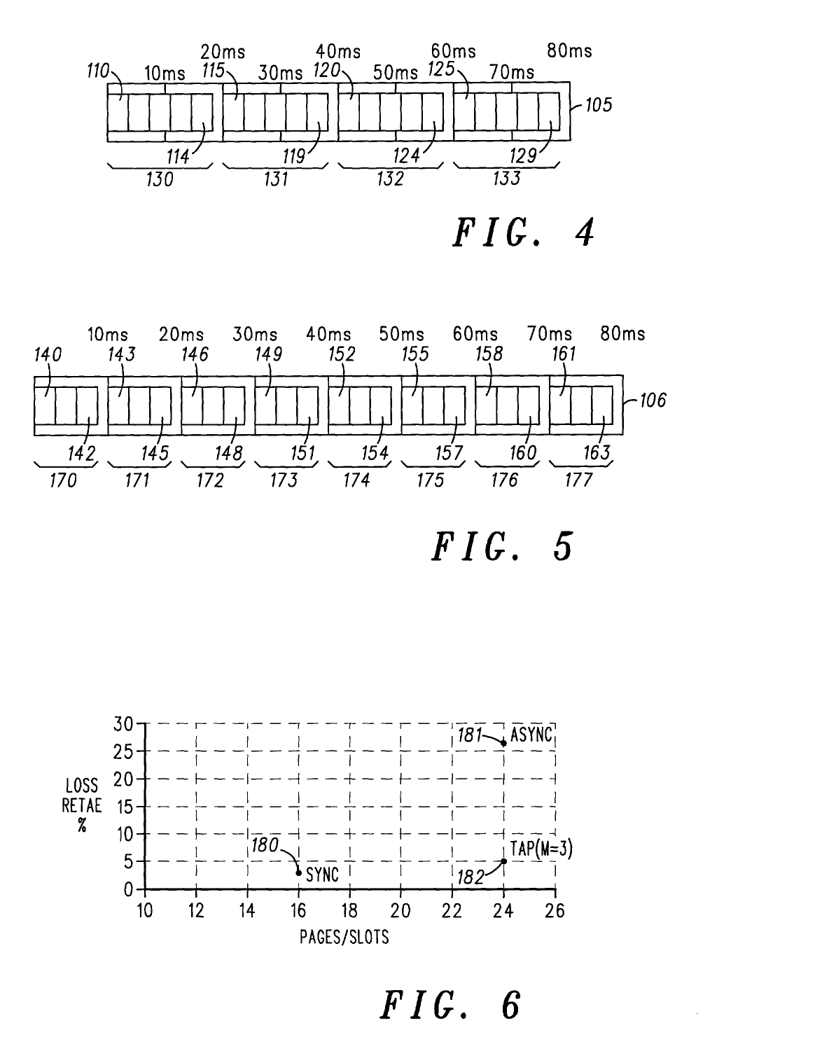

FIG. 6 shows a plot of the number of pages per slot versus the loss rate for the various paging systems described. FIG. 6 depicts the paging loss rate assuming one millisecond fade durations occurring randomly with an average interval of 150 milliseconds, points of the number of pages per slot versus the loss rate percentage for those paging messages for the various paging modes. For the synchronous system, point 180 of the plot indicates a maximum of 16 paging messages per 80 millisecond slot and an approximate loss rate of three to four percent. This is an acceptable loss rate, however, the throughput of paging messages is very low. That is, the number of paging messages transmitted through the paging slot is limited to 16.

For the asynchronous paging method, point 181 of the plot depicts a number of pages per slot of 24 and a loss rate of 26 to 27 percent. This is an unacceptable loss rate. Modern telecommunication systems for paging may not operate with such an excessive loss rate. Therefore, the asynchronous mode is unusable for paging.

For the Truncated Asynchronous Paging method as shown in FIG. 5, with the message length per group of three point 182 of the plot indicates that there are a maximum of 24 paging messages per 80 millisecond timeslot with a loss rate of slightly less that 5% for three paging messages per group. Therefore, the truncated asynchronous paging with a paging message length of three provides the best combination of maximum messages per slot with the lowest loss rate due to fading.

The Truncated Asynchronous Paging arrangement shown above increases the paging message capacity of each paging slot by 50% over use of the synchronous Paging mode. Furthermore, the Truncated Asynchronous paging mode retains the high resistance to fade loss of the synchronous paging mode. Use of the truncated asynchronous paging mode eliminates the need for operating companies to add extra forward common control channels or from using precious traffic channels to achieve higher paging message throughput.

Although the preferred embodiment of the invention has been illustrated, and that form described in detail, it will be readily apparent to those skilled in the art that various modifications may be made therein without departing from the spirit of the present invention or from the scope of the appended claims.

What is claimed is:

1. A method for providing paging messages by a communication system comprising the steps of:
providing a plurality of paging messages; and
formatting said plurality of paging messages into N message groups of M paging messages per group.

2. The method as claimed in claim 1, wherein there is further included the step of inserting the formatted N message groups of M paging messages per group into a slot of a particular time length.

3. The method as claimed in claim 2, wherein the particular time length is approximately 80 milliseconds.

4. The method as claimed in claim 2, wherein there is further included the step of transmitting the slot including the formatted plurality of paging messages over the air to at least one paging device.

5. The method as claimed in claim 1, wherein the step of formatting said plurality of paging messages into N message groups includes the step of formatting the plurality of paging messages into eight message groups.

6. The method as claimed in claim 1, wherein the step of formatting the plurality of paging messages into N message groups of M paging messages per group includes the step of formatting three paging messages per group.

7. The method as claimed in claim 1, wherein the step of formatting includes the steps of:
grouping the plurality of paging messages into eight message groups; and
grouping the plurality of paging messages into three paging messages per group.

8. The method as claimed in claim 1, wherein the step of formatting includes the step of aligning each group of N paging messages on a frame boundary.

9. A method for transmitting a plurality of paging messages to at least one paging device including the steps of:
transmitting a group of M paging messages to the at least one paging device;
waiting a predetermined time; and
iterating the steps of transmitting and waiting N times.

10. The method as claimed in claim 9, wherein there is further included the step of grouping the plurality of paging messages into M paging messages of N paging groups.

11. The method as claimed in claim 9, wherein there is further included the step of iterating the steps of transmitting and waiting for a particular time slot.

12. The method as claimed in claim 11, wherein the step of iterating the transmitting and waiting steps for the particular time slot includes the step of iterating the steps of transmitting and waiting for approximately 80 milliseconds.

13. The method as claimed in claim 9, wherein the step of waiting a predetermined time includes the step of aligning each group of N paging messages on a frame boundary.

14. The method as claimed in claim 9, wherein the steps of:
transmitting includes the step of transmitting a group of paging messages where N is in a range of from two to eleven; and
the step of iterating includes the step of correspondingly iterating the steps of transmitting and waiting M times where M is in a range of from two to eight.

15. The method as claimed in claim 9, wherein the steps of:
transmitting includes the step of transmitting a group of three paging messages; and
correspondingly the step of iterating includes the step of iterating the steps of transmitting and waiting eight times.

16. A paging message layout comprising:
a plurality of N groups of M paging messages per group, where N is an integer between two and eleven and M is an integer between two and eight; and
a time delay between each group of paging messages, so that each of the N groups is aligned on a frame boundary.

17. The paging message layout as claimed in claim 16 wherein there is further included a time slot, the plurality of N groups of M paging messages and the time delay between each group of M paging messages included within the time slot.

18. The paging message layout as claimed in claim 16, wherein the plurality of N groups of M paging messages includes three paging messages.

19. The paging message layout as claimed in claim 16, wherein the plurality of N groups of M paging messages includes eight groups of M paging messages.

20. The paging message layout as claimed in claim 16, wherein the plurality of N groups of M paging messages per group and time delay between each group of paging messages comprise a Truncated Asynchronous Paging mode.
